(19) United States
(12) Patent Application Publication
(10) Pub. No.: US 2014/0233243 A1
(43) Pub. Date: Aug. 21, 2014

(54) USE OF A LIGHT-DIFFUSING POLYCARBONATE SHEET AS A LIGHT COVER

(71) Applicant: BAYER MATERIALSCIENCE, GMBH, Darmstadt (DE)

(72) Inventors: Wojciech Kazimierz Cieplik, Leverkusen (DE); Emmanuel Bral, Eeklo (BE)

(73) Assignee: Bayer Intellectual Property GmbH, Monheim (DE)

(21) Appl. No.: 14/347,673

(22) PCT Filed: Sep. 27, 2012
(86) PCT No.: PCT/EP2012/069083

§ 371 Date: Mar. 27, 2014

(30) Foreign Application Priority Data
Sep. 28, 2011 (EP) 11183177.2

(51) Int. Cl. F21V 3/04; F21K 99/00

(52) U.S. Cl. CPC F21V 3/0445; F21K 9/50
USPC 362/311.02; 362/355

(57) ABSTRACT

The present invention therefore provides for the use of a light-diffusing polycarbonate sheet based on a composition comprising A) 99.9 to 80% by weight of polycarbonate and B) 0.1 to 20% by weight of diffusing pigment selected from at least one from the group of the silicone resins and the acrylate resins as a light cover, preferably in LED light applications.

The present invention relates to the use of a light-diffusing polycarbonate sheet as a light cover, preferably in LED illumination applications, for example in LED lights or LED light panels, and to the lighting unit, preferably LED lighting application (lighting unit with LED as the light source), comprising the light-diffusing polycarbonate sheet.

The prior art already discloses light-diffusing products composed of transparent polymers with various light-diffusing additives, and mouldings produced therefrom.

WO 2007/039130 and WO 2007/039131 describe PC compositions with Techpolymer as a diffusing pigment.

JP 05257002 describes light-diffusing PC sheets with diffusing pigments composed of silica.

JP 10046022 describes PC sheets with diffusing pigments composed of polyorganosiloxanes.

JP 08220311 describes two-layer sheets with a diffuser coextrusion layer of 5 to 25 μm, which comprise acrylic diffusing pigments. The diffusing pigments used here have a size of 0.1 to 20 μm.

JP 10046018 claims a polycarbonate containing 0.01 to 1% crosslinked polyacrylate spheres.

JP 2004/029091 describes PC diffuser sheets containing 0.3 to 20% diffusing pigment and 0.0005 to 0.1% optical brightener.

US 2004/0066645 A1 claims, in general terms, light-diffusing materials containing 0.2 to 5% light-diffusing particles, the light transmission being greater than 70% and the haze being at least 10%. The diffusing additive has a mean diameter of 3 to 10 μm.

JP 07-090167 claims a light-diffusing polymer which consists of 1 to 10% particles having a refractive index of less than 1.5 and a particle size of 1 to 50 μm, and 90 to 99% of an aromatic polycarbonate, wherein the particles essentially do not dissolve in the aromatic polycarbonate. The diffusing additives used are acrylate, polystyrene, glass, titanium dioxide or calcium carbonate particles.

EP 0 269 324 B1 describes diffusing additive compositions, and also light-diffusing thermoplastic polymer compositions comprising 0.1 to 10% diffusing additive.

In EP 0 634 445 B1, Paraloid EXL 5137 as a diffusing additive in combination with inorganic particles in polycarbonate among other materials is one, and 0.001 to 0.3% of these particles, for example titanium dioxide, contribute to an improvement in ageing resistance and hence colour stability.

JP 2004-053998 describes light-diffusing polycarbonate films having a thickness of 30 to 200 μm, which consist of more than 90% polycarbonate, have a light transmission of more than 90%, at least one side of the film surface having a concave-convex structure, and have a haze of at least 50% and a retardation of less than 30 nm. A use claimed for these optical films is as diffuser films in back-lighting units. The application describes and claims diffuser films with low birefringence (retardation <30 nm, better even <20 nm), since they bring about higher brightnesses in the BLU. The diffusing additives used are 1 to 10% inorganic particles, for example silicates, calcium carbonate or talc, or organic particles such as crosslinked acrylates or polystyrenes having a mean diameter of 1 to 25 μm, preferably of 2 to 20 μm.

JP 08-146207 describes optical diffuser films in which the surface has been structured by a shaping process on at least one side. Additionally claimed is a film in which only one transparent diffusing additive has been used and this is distributed inhomogeneously over the thickness of the film. If two or more diffusing additives are used, they may be distributed homogeneously over the thickness of the film. In the case of inhomogeneous distribution of the diffusing additive, enrichment takes place at the film surface. The diffusing additives used may be acrylate, polyethylene, polypropylene, polystyrene, glass, alumina or silica particles having a mean particle diameter of 1 to 25 μm. The films may have a thickness of 100 to 500 μm.

JP 2004-272189 describes optical diffuser sheets having a thickness of 0.3 to 3 mm, with use of diffusing additives having a particle diameter of 1 to 50 μm. It is additionally claimed that the brightness differences are less than 3% within a brightness range from 5000 to 6000 Cd/m².

WO 2004/090587 describes diffuser films having a thickness of 20 to 200 μm for use in LCDs which contain 0.2 to 10% diffusing additive and which have a degree of brilliancy of 20 to 70% on at least one side. The diffusing additives which have a particle diameter of 5 to 30 μm and are incorporated by compounding are crosslinked silicones, acrylates or talc.

DE 10 2009 025 123 describes a radiation-emitting device having an organic radiation-emitting functional layer and a radiation output layer.

WO 2006/127367 describes a backlight display device which a diffuser film comprising polycarbonate and diffusing pigment, the films being compact.

US 2010/328925 A1 describes a specific illumination device.

US 2007/0060704 discloses the use of polycarbonate compositions comprising diffusing pigments in diffuser sheets.

JP 06-123802 describes diffuser films having a thickness of 100 to 500 μm for LCDs, the refractive index difference between the transparent base material and the transparent light-diffusing particles being at least 0.05. One side of the film is smooth, while the diffusing additives protrude from the surface on the other side and form the structured surface. The diffusing additives have a particle diameter of 10 to 120 μm.

It is an object of the present invention to give LED lights, in spite of the use of cold white LEDs, a pleasant “warmer” light perception, and/or, in the case of use of RGB (red/green/blue) LEDs, to give the best possible trueness of colour or a pale bluish, “fresh” visual impression, irrespective of whether the LEDs are switched on or off. The PC sheet used for this purpose, also called diffuser sheet or diffusing sheet, should at the same time have maximum light transmission and the best possible light diffusion. This polycarbonate diffuser sheet additionally has much better flame retardancy and impact resistance compared to acrylic sheets. Moreover, the polycarbonate diffuser sheet can be thermoformed (including sharp edges) without completely losing the diffusing capacity.

It has been found that the light-diffusing polycarbonate sheet specified below fulfils these demands.

None of the documents cited above describes the use of the light-diffusing PC sheet described hereinafter as a light cover, more particularly at a distance of 15 mm, preferably 20 mm, especially 30 mm to 100 mm, preferably 80 mm, from the light source, preferably for LED applications. At a decency of less than 30 mm, the light points are generally visible. If this effect is desired, a corresponding distance of the light-diffusing sheet from the light source should be maintained. A further preferred distance is 50 mm to 80 mm. The documents do not disclose the use of the PC sheet described for achievement of the abovementioned requirements.

The present invention therefore provides for the use of a light-diffusing polycarbonate sheet based on a composition comprising
A) 99.9 to 80% by weight of polycarbonate and
B) 0.1 to 20% by weight of diffusing pigment selected from at least one from the group of the silicone resins and the acrylate resins as a light cover, preferably in LED light applications.

### Component A)

Suitable polycarbonates A) are all known polycarbonates as described, for example, in WO 2007/039130 and WO 2007/039131. These are homopolycarbonates, copolycarbonates and thermoplastic polyester carbonates. The polycarbonates are preferably prepared by the interfacial process from dihydroxyaryl compounds (also referred to hereinafter as diphenols) and phosgene, or the melt transesterification process from diphenols and diaryl carbonate derivatives.

Preferred diphenols are selected resorcinol, 4,4′-dihydroxydiphenyl, bis(4-hydroxyphenyl)diphenylmethane, 1,1-bis(4-hydroxyphenyl)-1-phenylethane, bis(4-hydroxyphenyl)-1-(1-naphthyl)ethane, bis(4-hydroxyphenyl)-1-(2-naphthyl)ethane, 2,2-bis(4-hydroxyphenyl)propane, 2,2-bis(3,5-dimethyl-4-hydroxyphenyl)propane, 1,1-bis(4-hydroxyphenyl)cyclohexane, 1,1-bis(3,5-dimethyl-4-hydroxyphenyl)cyclohexane, 1,1-bis(4-hydroxyphenyl)-3,3,5-trimethylcyclohexane, 1,1′-bis(4-hydroxyphenyl)-3-diisopropylbenzene and 1,1′-bis(4-hydroxyphenyl)-4-diisopropylbenzene. Mixtures of the diphenols can likewise be used.

Particular preference is given to 4,4′-dihydroxydiphenyl, 2,2-bis(4-hydroxyphenyl)propane or bis(4-hydroxyphenyl)-3,3,5-trimethylcyclohexane or mixtures thereof.

For preparation of copolycarbonates, it is also possible to use 1 to 25% by weight, preferably 2.5 to 25% by weight (based on the total amount of diphenols for use), of polydiorganosiloxanes having hydroxyaryloxy end groups.

Also suitable are polyester carbonates and block copolyester carbonates, particularly as described in WO 2000/26275. Aromatic dicarbonyl halides for preparation of aromatic polyester carbonates are preferably the diacid chlorides of isophthalic acid, terephthalic acid, diphenyl ether 4,4′-dicarboxylic acid and naphthalene-2,6-dicarboxylic acid.

Polydiorganosiloxane-polycarbonate block copolymers are characterized in that they contain, in the polymer chain, firstly aromatic carbonate structural units (1) and secondly polydiorganosiloxanes (2) containing aryloxy end groups (e.g. U.S. Pat. No. 3,189,662, U.S. Pat. No. 3,821,325 and U.S. Pat. No. 3,832,419).

Suitable polycarbonates preferably have mean molecular weights M̅_{w} of 18,000 to 40,000, preferably of 20,000 to 36,000 and especially of 23,000 to 33,000. The weight-average molecular weights Mw are each determined by gel permeation chromatography and calibration with polycarbonate standard.

The polycarbonates generally have MFR (Melt Flow Rate) values of 2 to 60 g/10 min, preferably 2 to 40 g/10 min, more preferably 3 to 18 g/10 min, especially of 5 to 13 g/10 min, measured based on ISO 1133 at a temperature of 300° C. and a load of 1.2 kg.

### Component B)

The diffusing pigments used may be all acrylate resins having a sufficiently high thermal stability up to at least 300° C. in order not to be decomposed at the processing temperatures of polycarbonate. Furthermore, pigments must not have any functionalities which lead to degradation of the polymer chain of the polycarbonate. Preferred acrylate resins are polyalkyl acrylates having preferably 2 to 8 carbon atoms in the alkyl group with a mean particle size (number average) of 0.5 μm to 80 μm, preferably 2 μm to 40 μm, especially 3 μm to 15 μm, especially 3 μm to 9 μm. Mixtures of alkyl acrylates can likewise be used (homo- or copolymers). The acrylate resins are preferably crosslinked. Suitable crosslinking agents are the crosslinking agents known for acrylates. Preferred crosslinking agents are glycol-based crosslinkers such as, more particularly, ethylene glycol dimethacrylate.

Particular preference is given to crosslinked polymethyl methacrylate, especially crosslinked with ethylene glycol dimethacrylate.

Commercially suitable polyalkyl acrylates are, for example, products from the Techpolymer® product group from Sekisui, Japan, Techpolymer® MBX-5 or MBX-8.

The silicone resins preferably have a mean particle size (number average) of 0.5 μm to 100 μm, preferably 0.5 μm to 20 μm, especially 1 μm to 6 μm.

In a preferred embodiment, the silicone resins are silsequioxanes, here preferably from the group of the alkyl silsesquioxanes, preferably C1 to C4-alkyl silsesquioxanes, more preferably methyl silsesquioxane.

Commercially suitable silsesquioxanes are, for example, products from the Tospearl® product group from Momentive, USA, Tospearl® TSR9000 or 120S.

The masterbatch contains generally 75 to 99.9% by weight, preferably 82 to 99%, more preferably 87 to 98% by weight of polycarbonate and 25 to 0.1% by weight, preferably 18 to 1% by weight, more preferably 10 to 2% by weight, of diffusing pigment B-1), based in each case on the masterbatch composition.

The diffusing pigments are generally used in the form of a masterbatch, preferably in polycarbonate. Suitable polycarbonates for the production of the masterbatch are the abovementioned polycarbonates.

### Component B-1—Acrylates

The masterbatch contains generally 60 to 99.9% by weight, preferably 70 to 99%, more preferably 77 to 98% by weight of polycarbonate and 40 to 0.1% by weight, preferably 30 to 1% by weight, more preferably 20 to 2% by weight, of diffusing pigment B-1), based in each case on the masterbatch composition.

### Component B-2—Silicone Resins

The masterbatch contains generally 75 to 99.9% by weight, preferably 82 to 99%, more preferably 87 to 98% by weight of polycarbonate and 25 to 0.1% by weight, preferably 18 to 1% by weight, more preferably 10 to 2% by weight, of diffusing pigment B-2), based in each case on the masterbatch composition.

The masterbatches are produced by commonly known methods, for example by mixing the components and then compounding on kneader-extruders (single-screw or twin-screw extruders) or customary extrusion machines.

The thickness of the PC sheet which is used for LED light applications is generally 0.5 mm to 10 mm, preferably 0.8 mm to 8 mm, more preferably 1 mm to 5 mm and especially 1 mm to 3.5 mm.

When a bluish and hence cool light perception is preferred, a silicone resin-based masterbatch is used, and this is preferably used with an optical brightener. A preferred the amount of the silicone resin for this use form is preferably 0.1 to 1% by weight based on components A) and B).

The PC sheets may therefore, in a further embodiment, additionally contain 0.001 to 2% by weight, more preferably 0.003 to 0.8% by weight, more preferably 0.004 to 0.2% by weight, 0.005 to 0.015% by weight, more preferably 0.005 to 0.01% by weight (based on the overall composition) of an optical brightener. Suitable optical brighteners are those from the structure class of the bisbenzoxazoles, phenylcoumarins or bisstyrylbiphenyls.

A preferred optical brightener is 2,5-thiophenediylbis(5-tert-butyl-1,3-benzoxazole), which is available, for example, under the Uvitex OB trade name from BASF SE, Ludwigshafen or Eastobrite OB trade name from Eastman Chemical Comp.

In addition, the composition of the PC sheet may contain 0.01 to 10% by weight of UV absorbers. Suitable UV absorbers are, for example, benzotriazole derivatives, dimeric benzotriazole derivatives, triazine derivatives, dimeric triazine derivatives and diaryl cyanoacrylates. They are preferably used in an amount of 0.01 to 1% by weight based on the overall composition.

UV absorbers of the benzotriazole type are, for example and with preference, 2-(3′,5′-bis(1,1-dimethylbenzyl)-2′-hydroxyphenyl)benzotriazole (Tinuvin® 234, BASF SE, Ludwigshafen), 2-(2′-hydroxy-5′-(tert-octyl)phenyl)benzotriazole (Tinuvin® 329, BASF SE, Ludwigshafen), 2-(2′-hydroxy-3′-(2-butyl)-5′-(tert-butyl)phenyl)benzotriazole (Tinuvin® 350, BASF SE, Ludwigshafen) and bis(3-(2H-benztriazolyl)-2-hydroxy-5-tert-octyl)methane, (Tinuvin® 360, BASF SE, Ludwigshafen).

UV absorbers of the triazine type are, for example and with preference, (2-(4,6-diphenyl-1,3,5-triazin-2-yl)-5-(hexyloxy)phenol (Tinuvin® 1577, BASF SE, Ludwigshafen), and 2-[2-hydroxy-4-(2-ethylhexy)oxy]phenyl-4,6-di(4-phenyl)phenyl-1,3,5-triazine (CGX UVA 006, BASF SE, Ludwigshafen).

UV absorbers of the benzophenone type are, for example and with preference, 2,4-dihydroxybenzophenone (Chimasorb® 22, BASF SE, Ludwigshafen) and 2-hydroxy-4-(octyloxy)benzophenone (Chimasorb® 81, BASF SE, Ludwigshafen).

In addition, it is possible to use UV absorbers from the classes of the cyanoacrylates and of the malonates, for example and with preference 1,3-bis[(2′-cyano-3′,3′-diphenylacryloyl)oxy]-2,2-bis{[(2′-cyano-3′,3′-diphenylacryloyl)oxy]methyl}propane (Uvinul® 3030, BASF SE Ludwigshafen), or tetraethyl 2,2′-(1,4-phenylenedimethylidene)bismalonate (Hostavin® B-Cap, Clariant AG).

As further additives and processing aids, it is possible to add stabilizers, demoulding aids and/or antistats. Suitable stabilizers are, for example, phosphines, phosphites or Si-containing stabilizers, and further compounds described in EP-A 0 500 496. Examples include triphenyl phosphites, diphenyl alkyl phosphites, phenyl dialkyl phosphites, tris(nonylphenyl) phosphite, tetrakis(2,4-di-tert-butylphenyl) 4,4′-biphenylenediphosphonite, bis(2,4-dicumylphenyl) pentaerythrityl diphosphite and triaryl phosphite. Particular preference is given to triphenylphosphine and tris(2,4-di-tert-butylphenyl) phosphite. Suitable demoulding agents are, for example, the esters or partial esters of mono- to hexahydric alcohols, especially of glycerol, of pentaerythritol or of Guerbet alcohols.

Monohydric alcohols are, for example, stearyl alcohol, palmityl alcohol and Guerbet alcohols, a dihydric alcohol is, for example, glycol, a trihydric alcohol is, for example, glycerol, tetrahydric alcohols are, for example, pentaerythritol and mesoerythritol, pentahydric alcohols are, for example, arabitol, ribitol and xylitol, and hexahydric alcohols are, for example, mannitol, glucitol (sorbitol) and dulcitol.

The esters are preferably the monoesters, diesters, triesters, tetraesters, pentaesters and hexaesters or mixtures thereof, especially random mixtures, of saturated aliphatic C₁₀ to C₃₆-monocarboxylic acids and optionally hydroxymonocarboxylic acids, preferably with saturated, aliphatic C₁₄ to C₃₂-monocarboxylic acids and optionally hydroxymonocarboxylic acids.

The commercially available fatty acid esters, especially of pentaerythritol and of glycerol, may contain <60% of different partial esters as a result of the preparation.

Saturated aliphatic monocarboxylic acids having 10 to 36 carbon atoms are, for example, capric acid, lauric acid, myristic acid, palmitic acid, stearic acid, hydroxystearic acid, arachic acid, behenic acid, lignoceric acid, cerotic acid and montanic acids.

Examples of suitable antistats are cation-active compounds, for example quaternary ammonium, phosphonium or sulphonium salts, anion-active compounds, for example alkyl sulphonates, alkyl sulphates, alkyl phosphates, carboxylates in the form of alkali metal or alkaline earth metal salts, nonionic compounds, for example polyethylene glycol esters, polyethylene glycol ethers, fatty acid esters, ethoxylated fatty amines. Preferred antistats are nonionic compounds.

The composition may comprise further pigments such as yellow pigments or titanium dioxide. In this way, the hue can be deepened.

The PC sheet may be provided on one or both sides with a UV protection layer, for example PC containing UV absorber, or a coating layer containing UV absorber. Suitable UV absorbers are those mentioned above.

Components A and B and optionally further additives are mixed and compounded in a customary manner, and processed to give granules. Known extrusion processes produce PC sheets from the granules.

For extrusion, polycarbonate granules are supplied to the extruder and melted in the plasticizing system of the extruder. The polymer melt is forced through a slot die and shaped, and converted to the desired final shape in the roll nip of a smoothing calender, and the shape is fixed by reciprocal cooling on chill rolls and with the ambient air. The polycarbonates having high melt viscosity which are used for extrusion are typically processed at melt temperatures of 260 to 320° C., preferably 270 to 300° C., and the barrel temperatures of the plasticizing barrel and die temperatures are set accordingly.

Through use of coextruders, polycarbonate melts of varying composition can be superposed. By means of coextrusion, it is possible, for example, to apply UV protection layers.

The PC diffusing sheets serve as what is called a light shield or light cover for a lighting unit, preferably lighting unit with LEDs as the light source.

The present invention therefore also provides the lighting unit, preferably LED lighting unit, comprising the abovementioned PC sheet. The diffusing sheet preferably has a distance of 50 to 80 mm from the light source, preferably from the LEDs. At this distance, the best diffusion and hence an excellent light perception are achieved.

The reduction in the light temperature through the use of the polycarbonate sheet as a light cover compared to the light temperature of the LED is, in the case of warm white light, at least 150 to a maximum of 500 K, preferably 200 to 400 K. In the case of cold white/bluish light, the reduction is at least 80 K and a maximum of 150 K. The delta in the light temperature, i.e. the reduction, was measured here on a polycarbonate sheet having a thickness of 3 mm. The light temperature is determined by means of a spectrophotometer (DIN 5033). The lights or lighting units, especially LED lights or LED lighting units, comprising these diffusing sheets can be used, for example, as office lighting, street lighting, floor lighting etc., in and as advertising panels. They are also suitable for decorative purposes, and also as façade lighting and in refrigerators.

The examples which follow are intended to illustrate the invention, but without restricting it.

### EXAMPLES

### Component A)

A1) Makroion® 2600 from Bayer Material Science AG, a polycarbonate based on bisphenol A having an MVR of, measured (measured on the basis of DIN EN ISO 1133 at load 1.2 kg and 300° C.) 11.5 g/10 min
A2) Makrolon® 2805MAS152 from Bayer Material Science AG, a polycarbonate based on bisphenol A having an MVR of (measured on the basis of DIN EN ISO 1133 at load 1.2 kg and 300° C.) 10 g/10 min

### Component B)

B1) Techpolymer MBX-5 from Sekisui, Japan, an acrylate resin (methyl methacrylate/ethylene glycol dimethacrylate copolymer) having a particle size of 2 to 15 μm and a mean particle size of 5 μm.
B2) Tospearl TRS9000 from Momentive Performance Materials, Germany, a silicone resin having a mean particle size of 2 μm.

Masterbatch (MB) 1 was produced from:
77.9% by weight of Makrolon® 2600
20% by weight of Techpolymer according to B1)
0.10% by weight of triphenylphosphine and 2% by weight of a phosphorous ester as a further thermal stabilizer

Masterbatch (MB) 2 was produced from:
88.35% by weight of Makrolon® 2805MAS152
10% by weight of Tospearl 9000 according to B2) and
1.10% by weight of Eastobrite OB
0.55% by weight of antioxidants

### Example 1

A compound of the following composition was produced:
93.5% by weight of polycarbonate A1)
6.5% by weight of masterbatch B1) (corresponds to 1.3% by weight of Techpolymer according to B1 in the composition)

### Example 2

A compound of the following composition was produced:
97% by weight of polycarbonate A2
3% by weight of masterbatch B2 (corresponds to 0.3% by weight of Tospearl according to B2 in the composition)

The compositions according to Examples 1 and 2 were used to produce sheets, by mixing the components and extruding them to sheets.

Sheet 1 produced from the composition according to Example 1 has a thickness of 3 mm.

The light transmission τ_{(A)} or τ_{(D65)} was determined for the CIE standard illuminant A and D65 and the light diffusion factor σ.

The light transmission was measured to CIE 130-1998 with a spherical photometer having a diameter of 1.5 m within the visible wavelength range.

The light transmission τ_{(A)} for sheet 1 is 0.72; the comparative value τ_{(D65)} is 0.72. The light diffusion factor was measured to DIN 5036 with a pivoting arm apparatus using a photometer of the L class (from LMT) and a photometer of the A class (from Czibula & Grundmann GmbH).

The light diffusion factor σ at a half-value angle γ of 60° for sheet 1 is 0.65.

In addition, the light temperature was measured (by means of a spectrophotometer). The light temperature of the LED is 5940° K, and that of the LED covered with sheet 1 (thickness 3 mm) is 5718 K. The difference is 222 K.

The LED covered with sheet 1 therefore has more pleasant light radiation than the LED.

1-14. (canceled)

15. A method comprising utilizing a light-diffusing polycarbonate sheet based on a composition comprising
A) 99.9 to 80% by weight of polycarbonate and
B) 0.1 to 20% by weight of diffusing pigment selected from at least one from the group of the silicone resins and the acrylate resins
as a light cover.

16. The method according to claim 15 as a light cover in a LED light application.

17. The method according to claim 15, wherein the polycarbonate sheet is at a distance of 15 mm to 80 mm from the light source.

18. The method according to claim 15, wherein the composition contains 0.1 to 20% by weight of silicone resin and 0.005 to 0.01% by weight of an optical brightener, and the remaining amount to 100% by weight is a polycarbonate.

19. The method according to claim 15, wherein silicone resin is in an amount of 0.1 to 1% by weight based on components A) and B).

20. The method according to claim 18, wherein silicone resin is in an amount of 0.1 to 1% by weight based on components A) and B) and optical brightener.

21. The method according to claim 17, wherein the sheet is at a distance of 30 mm to 80 mm.

22. The method according to claim 19, wherein the optical brightener is present in an amount of 0.005 to 0.015% by weight.

23. The method according to claim 15, wherein the polycarbonate sheet has a thickness of 0.5 mm to 12 mm.

24. The method according to claim 15, wherein the polycarbonate sheet has a thickness of 1 mm to 6 mm.

25. The method according to claim 15, wherein the polycarbonate sheet has a thickness of 1 mm to 3.5 mm.

26. A lighting unit comprising a polycarbonate sheet based on a composition comprising
A) 99.9 to 80% by weight of polycarbonate and
B) 0.1 to 20% by weight of diffusing pigment selected from at least one from the group of the silicone resins and the acrylate resins.

27. The lighting unit according to claim 24, comprising a polycarbonate sheet and LEDs.

28. The method according to claim 15 for production of warm white or cold white bluish light, wherein the polycarbonate sheet is fixed at a distance of 50 mm to 80 mm from the light source.
